(19) United States
(12) Patent Application Publication
(10) Pub. No.: US 2007/0192826 A1
(43) Pub. Date: Aug. 16, 2007

(54) I/O-based enforcement of multi-level computer operating modes

(75) Inventors: Alexander Frank, Bellevue, WA (US); William J. Westerinen, Sammamish, WA (US); Issac P. Ahdout, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/353,677

(22) Filed: Feb. 14, 2006

(51) Int. Cl. H04L 9/00

(52) U.S. Cl. 726/1

(57) ABSTRACT

A computer is architected so that a monitoring and enforcement of an operating policy is carried out at an interface circuit that transmits data between a processor and one or more function blocks. The function blocks may include system memory, a display, a network, a USB port, or a non-volatile memory. Since the interface circuit handles every transaction between the processor and its supported function blocks, the interface circuit is an effective point at which to enforce limited performance modes when the computer's usage is not in compliance with the operating policy.

### BACKGROUND

Pay-as-you-go or pay-per-use business models have been used in many areas of commerce, from cellular telephones to commercial laundromats. In developing a pay-as-you go business, a provider, for example, a cellular telephone provider, offers the use of hardware (a cellular telephone) at a lower-than-market cost in exchange for a commitment to remain a subscriber to their network. In this specific example, the customer receives a cellular phone for little or no money in exchange for signing a contract to become a subscriber for a given period of time. Over the course of the contract, the service provider recovers the cost of the hardware by charging the consumer for using the cellular phone.

The pay-as-you-go business model is predicated on the concept that the hardware provided has little or no value, or use, if disconnected from the service provider. To illustrate, should the subscriber mentioned above cease to pay his or her bill, the service provider deactivates their account, and while the cellular telephone may power up, calls cannot be made because the service provider will not allow them. The deactivated phone has no “salvage” value, because the phone will not work elsewhere and the component parts are not easily salvaged nor do they have a significant street value. When the account is brought current, the service provider will reconnect the device to network and allow making calls.

This model works well when the service provider, or other entity taking the financial risk of providing subsidized hardware, has a tight control on the use of the hardware and when the device has little salvage value. This business model does not work well when the hardware has substantial uses outside the service provider's span of control. Thus, a typical personal computer does not meet these criteria since a personal computer may have substantial uses beyond an original intent and the components of a personal computer, e.g. a display or disk drive, may have a significant salvage value.

Enforcing an operating policy that requires payment of subscription fees or pay-per-use fees will encourage users to meet their financial commitments to an underwriter that subsidizes the purchase price of the computer. However, enforcement circuits will draw the attention of hackers or thieves who wish to benefit themselves by stealing computer services or by stealing the computer itself.

### SUMMARY

A computer configured to self-monitor and enforce compliance to an operating policy, such as a pay-per-use operating policy or a subscription operating policy, may use an interface circuit configured to impede access to peripheral and support circuits when non-compliance to the operating policy is determined.

When the interface circuit supports system memory or the display, the enforcement may be through limiting the amount of memory available for program execution or may limit the display with reduced colors or a reduced number of displayed pixels.

When the interface circuit manages most or all of the other system input/output (I/O), for example, data transfer with network ports, serial interfaces, card slots, non-volatile memory, BIOS memory, a keyboard and mouse, and the like, the interface circuit may enforce the operating policy by limiting access between any of these function blocks and the processor. Limiting access in this case may include reduced data transfer rates, limits on data transfer, read-only or write-only storage access, and restricted peripheral access, to mention a few. The result may be to allow a range of sanctions from minimal to extreme, depending on the nature of the perceived violation, prior violation history, or contractual rules.

### BRIEF DESCRIPTION OF THE DRAWINGS

FIG. 1 is a block diagram of a computer;

FIG. 2 is a block diagram of an architecture of a computer similar to the computer of FIG. 1;

FIG. 2A is a block diagram of an alternate architecture of the computer of FIG. 2; and

FIG. 3 is an interface circuit suitable for use in the computer of FIGS. 2 or 2A.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

Many prior-art high-value computers, personal digital assistants, organizers and the like are not suitable for use in a pre-pay or pay-for-use business model as is. As discussed above, such equipment may have significant value apart from those requiring a service provider. For example, a personal computer may be disassembled and sold as components, creating a potentially significant loss to the underwriter of subsidized equipment. In the case where an Internet service provider underwrites the cost of the personal computer with the expectation of future fees, this “untethered value” creates an opportunity for fraudulent subscriptions and theft. Pre-pay business models, where a user pays in advance for use of a subsidized, high value computing system environment have similar risks of fraud and theft.

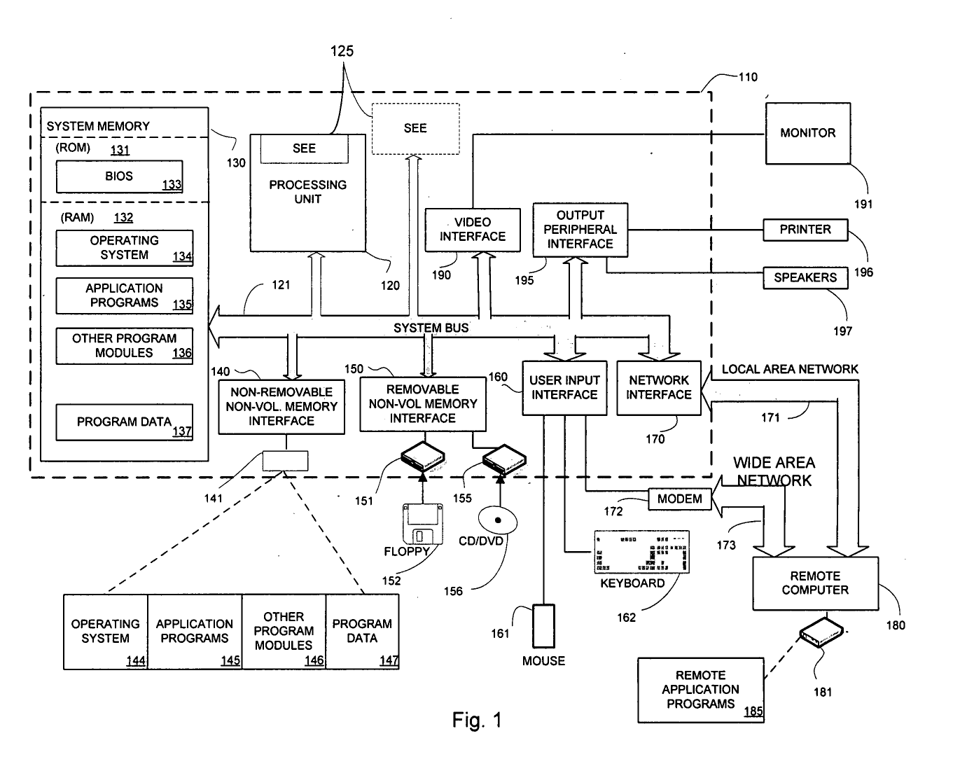

FIG. 1 illustrates a computing device in the form of a computer 110 that may be connected to a network, such as local area network 171 or wide area network 173 and used to host one or more instances of a secure execution environment. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

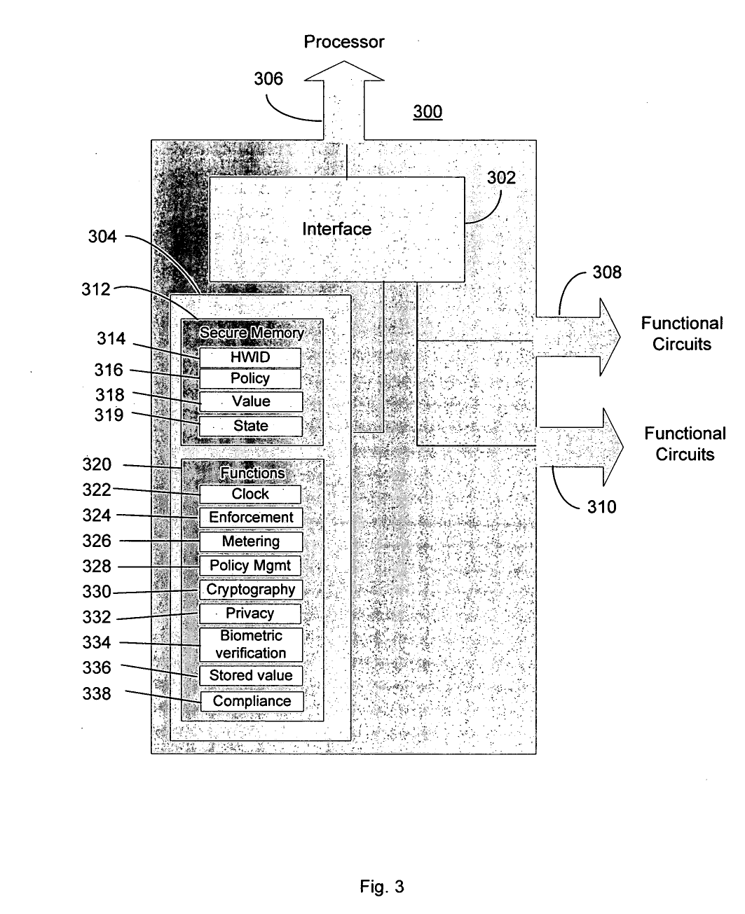

The computer 110 may include a secure execution environment 125 (SEE). The SEE 125 may be enabled to perform security monitoring, pay-per-use and subscription usage management and policy enforcement for terms and conditions associated with paid use, particularly in a subsidized purchase business model. The secure execution environment 125 may be embodied in the processing unit 120 or as a standalone component as depicted in FIG. 1. The detailed functions that may be supported by the SEE 125 and additional embodiments of the SEE 125 are discussed below with respect to FIG. 3.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

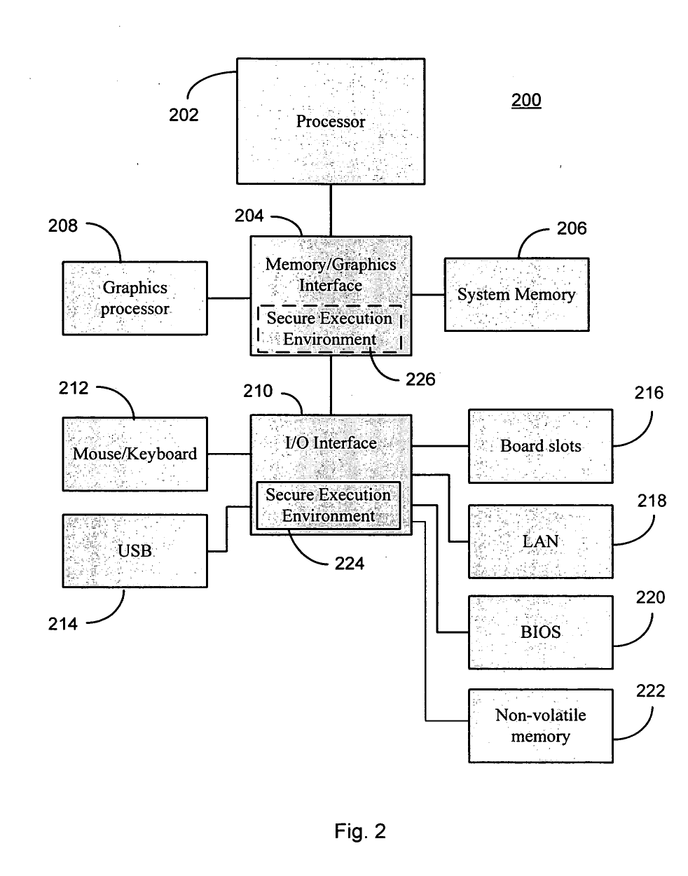

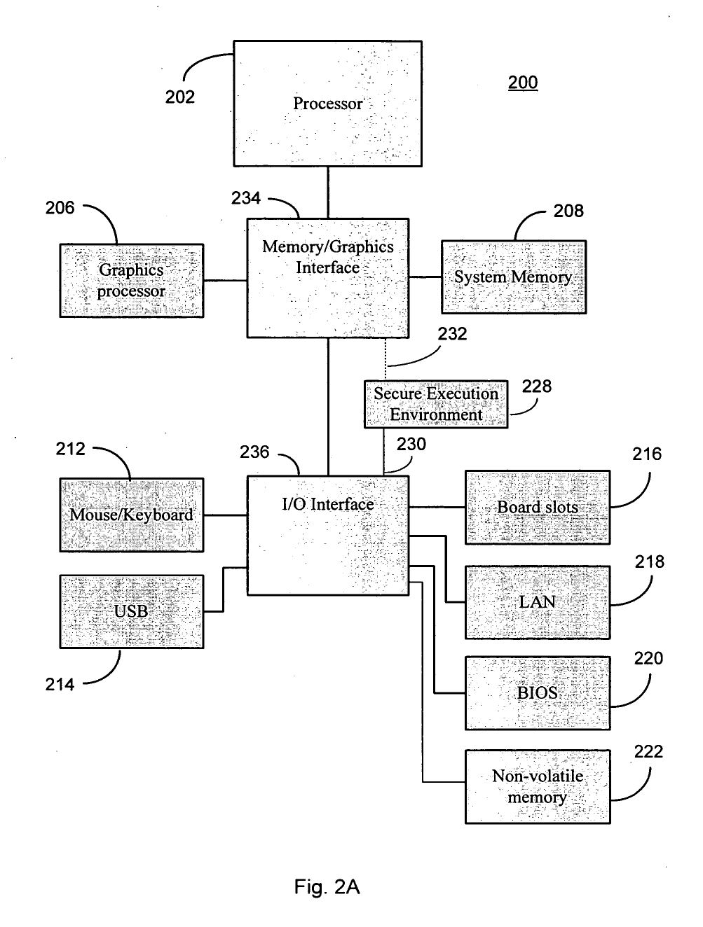

FIG. 2 is an architectural block diagram of a computer 200 the same as or similar to the computer of FIG. 1. The architecture of the computer 200 of FIG. 2 may be typical of general-purpose computers widely sold and in current use. A processor 202 may be coupled to a graphics and memory interface 204. The graphics and memory interface 204 may be a “Northbridge” controller or its functional replacement in newer architectures, such as a “Graphics and AGP Memory Controller Hub” (GMCH). The graphics and memory interface 204 may be coupled to the processor 202 via a high speed data bus, such as the “Front Side Bus” (FSB), known in computer architectures. The processor 202 may also be connected, either directly or through the graphics and memory interface 204, to an input/output interface 210 (I/O interface). The I/O interface 210 may be coupled to a variety of devices represented by, but not limited to, the components discussed below. The I/O interface 210 may be a “Southbridge” chip or a functionally similar circuit, such as an “I/O Controller Hub” (ICH). Several vendors produce current-art Northbridge and Southbridge circuits and their functional equivalents, including Intel Corporation.

A variety of functional circuits may be coupled to either the graphics and memory interface 204 or the I/O Interface 210. The graphics and memory interface 204 may be coupled to system memory 206 and a graphics processor 208, which may itself be connected to a display (not depicted). A mouse/keyboard 212 may be coupled to the I/O interface 210. A universal serial bus (USB) 214 may be used to interface external peripherals including flash memory, cameras, network adapters, etc. (not depicted). Board slots 216 may accommodate any number of plug-in devices, known and common in the industry. A local area network interface (LAN) 218, such as an Ethernet board may be connected to the I/O interface 210. Firmware, such as a basic input output system (BIOS) 220 may be accessed via the I/O interface 210. Nonvolatile memory 222, such as a hard disk drive or any of the other non-volatile memories listed above, may also be coupled to the I/O interface 210.

A secure execution environment 224 is shown disposed in the I/O interface 210. An alternate embodiment, showing another secure execution environment 226 disposed in the graphics and memory interface 204 is also shown. While system configurations with more than one secure execution environment are supported, one embodiment is directed to a single instance of the secure execution environment. An interface circuit with an integral secure execution environment, such as secure execution environment 224 or secure execution environment 226 is discussed in more detail with respect to FIG. 3.

FIG. 2A is an alternate embodiment of the computer of FIG. 2. In this embodiment, a secure execution environment 228 is not disposed in one of the interface circuits 234 and 236, but is a separate unit. The secure execution environment 228 may be coupled to the I/O interface 236 by bus 230. Similarly, when configured with the graphics and memory interface 234, the secure execution environment 228 may be coupled to the graphics and memory interface 234 via bus 232. The separate busses 230 and 232 may be used so as not to interfere with the very high data rates between the processor 202, the graphics and memory controller 234, and the I/O interface 236. A lower speed bus may satisfy the requirements of such an implementation, for example, an inter-integrated circuit bus (IIC or I²C), known in the art. When configured in this manner, the busses 230 and 232 may have data transfers in the clear and depend on physical means to protect the data, such as the busses being buried in the circuit board. In another embodiment, the data on busses 230 and 232 may be encrypted, requiring support for secure communications in the two interface circuits 234 236, respectively. While such support may be inherent in the secure execution environment 228, it may be an additional requirement on either the graphics and memory interface 234 or the I/O interface 236.

FIG. 3 is a block diagram of an exemplary interface circuit 300, such as the graphics and memory controller 204 or the I/O interface 210. The interface circuit 300 may include the actual interface circuitry 302 such as switches, multiplexers and buffers which are not depicted. The interface circuit 300 may be connected directly to a processor, such as the graphics and memory controller 204, or may be connected indirectly through another circuit, such as the I/O interface 210, as shown in FIG. 2, or interface circuits 234 and 236 of FIG. 2A. A bus interface 306 may interface directly or indirectly with the processor and bus interfaces 308 and 310 may couple to a variety of functional circuits, including, but not limited to, a graphics processor, system memory, non-volatile memory, human I/O such as the keyboard and mouse, a USB port, and networking connections.

The interface circuit 300 may also include a secure execution environment 304 coupled to the interface circuits. The secure execution environment 304 may include a secure memory 312 that may be used to store data such as a hardware identifier 314, policy settings 316, stored value 318, and a state register 319. The hardware identifier 314 may uniquely identify the particular secure execution environment and by association, the computer. The policy 316 may include terms of use and progressive steps of enforcement should the terms of use be violated. The stored value 318 may represent minutes of usage available, the expiration date of a monthly subscription, or may represent actual value such as purchase credits that can be used for either usage or unrelated purchases, such as accessories.

The state register 319 may store a value indicating the operating mode of the computer. Each state value may represent a different operating state. One state value may represent unrestricted use, another state value may represent a reduced function mode that allows entry of a payment, while a third state value may represent a mode allowing configuration of a network connection (network configuration may be required to allow payment entry, and may be associated with the payment entry mode). Another state value may represent a reduced function mode that allows retrieval of data, allowing backup of a system that has been placed in a restricted operating mode. Another state value may represent a more restrictive mode of operation which only allows entry of a recovery code, that is, a signed message that may be interpreted directly by the secure execution environment 304, and when correct, restores the system to unrestricted operation. Yet another state value may represent a disable mode that allows no user interaction, but rather requires an authorized service technician with access to special hardware or software tools to reactivate the computer. These latter modes may restrict operation to a small kernel that has a known location, such as in the secure memory 312 of the secure execution environment 304. Referring to FIG. 2, because all memory access is via one of the interface circuits 204 210, processor 202 access to this special kernel may be enforced by the associated secure execution environment 226 224 of the interface circuit 204 210. The restricted operating modes listed above may comprise a set of restricted operating modes that may be selected from according to the nature of the event that triggers a sanction and the requirements of the current policy with respect to that event.

The secure execution environment 304 may also include a set of functions 320 supporting pay-per-user or subscription operation. The functions may be implemented in a number of fashions, for example, one embodiment may use firmware such as a programmable logic array and another embodiment may include a processor or controller (not depicted) in the secure execution environment to implement the functions in software.

The functions 312 may include, but are not limited to, a clock 322 or timer implementing clock functions, enforcement functions 324, metering 326, policy management 328, cryptography 330, privacy management 332, biometric verification 334, stored value 336, and compliance monitoring 338.

The clock 322 may provide a reliable basis for time measurement and may be used as a check against a system clock maintained by an operating system, such as operating system 134 of the computer 110 to help prevent attempts at fraudulent by altering the system clock. The clock 322 may also be used in conjunction with policy management 328, for example, to require communication with a host server to verify upgrade availability. The enforcement functions 324 may be executed when it is determined that the computer 110 is not in compliance with one or more elements of the policy 316. Such actions may include restricting system memory access by reallocating generally available system memory to a non-accessible resource, such as the secure execution environment 224 226. The system memory 206 is essentially made unavailable for user purposes by this reallocation process.

Another function 320 may be metering 326. Metering 326 may include a variety of techniques and measurements, for example, those discussed in co-pending U.S. patent application Ser. No. 11/006,837. When to activate metering and what specific items to measure may be a function of the policy 316. The selection of an appropriate policy 316 and the management of updates to the policy 316 may be implemented by the policy management function 328. The policy management function 328 may request and receive updated policies and be responsible for verification of new policies as well as their installation.

A cryptography function 330 may be used for digital signature verification, digital signing, random number generation, and encryption/decryption. Any or all of these cryptographic capabilities may be used to verify updates to the secure memory 312 or to established trust with an entity outside the secure execution environment 304 whether inside or outside of the computer 110.

The secure execution environment 304 may allow several special-purpose functions to be developed and used. A privacy manager 332 may be used to manage personal information for a user or interested party. For example, the privacy manager 332 may be used to implement a “wallet” function for holding address and credit card data for use in online purchasing. A biometric verification function 334 may be used with an external biometric sensor (not depicted) to verify personal identity. Such identity verification may be used, for example, to update personal information in the privacy manager 332 or when applying a digital signature. The cryptography function 330 may be used to establish trust and a secure channel to the external biometric sensor.

A stored value function 336, in conjunction with the stored value 318, may also be implemented for use in paying for time or subscriptions on a paid-use computer or while making external purchases, for example, online stock trading transactions.

Compliance monitoring 338 may be a single test or a combination of tests. The test or tests may be used assure the integrity of the computer with respect to metering, the overall integrity of the computer hardware and software, specifically the integrity of the secure execution environment 304. Compliance monitoring 338 may involve functions that verify specific software versions, for example, a version of the operating system 134. Another compliance check may verify, for a pay-per-use computer, that time consumed (metered) is consistent with time purchased as a check that metering is not being tampered.

In one embodiment, the computer 200 may boot using a normal BIOS startup procedure. At a point when the operating system 134 is being activated, the policy management function 328 may be activated. The policy management function 328 may determine that the current policy 316 is valid and then load the policy data 216. The policy 316 may be used in a configuration process to set up the computer 200 for operation. The configuration process may include allocation of memory, processing capacity, peripheral availability and usage as well as metering requirements. When metering is to be enforced, policies relating to metering, such as what measurements to take may be activated. For example, measurement by CPU usage (pay-per-use) versus usage over a period of time (subscription), may require different measurements. Additionally, when usage is charged per period or by activity, a stored value balance 318 may be maintained using the stored value function 336. When the computer 200 has been configured according to the policy 316, the normal boot process may continue by activating and instantiating the operating system 134 and other application programs 135. In other embodiments, the policy 316 may be applied at different points in the boot process or normal operation cycle.

Should non-compliance to the policy be discovered, the enforcement function 324 may be activated. Because the policy management and enforcement functions 328 324 are maintained within the secure execution environment 304, some typical attacks on the system are difficult or impossible. For example, the policy 316 may not be “spoofed” by replacing a policy memory-section of external memory. Similarly, the policy management and enforcement functions 328 324 may not be “starved” by blocking execution cycles or blocking their respective address ranges.

Specific enforcement functions maybe required when the either the available time is depleted through normal use, or when the computer falls into a state of noncompliance either by accident or intention. Either the metering function 326 or the compliance function 338 can change the state register 319 setting from that representing normal, unrestricted use to a setting associated with enforcement. That may cause the enforcement function 324 to be activated. When the secure execution environment 304 is disposed in or coupled to an interface circuit, such as the graphics and memory interface 204 or the I/O interface 210, a rich range of enforcement options may be available. Because the interface circuits are well positioned to interact with most, if not all, of the functions of the computer and because the interface circuits 204 210 stand between those functions and the processor, the interface circuits 204 210 may be able to fine tune a range of sanctions, as needed.

The graphics and memory interface 204 may allow sanctions based involving system memory and the display output. When the system memory 206 is sanctioned, the available system memory available for use by the processor 202 may be cut dramatically, to less than 25% of the normally available system memory. The impact may be to slow processing or limit advanced functions, such as image editing. Another sanction involving system memory 206 may be to limit the memory to a fixed amount, for example, from 512 Mbytes to 10 Mbytes. If page swapping is also restricted, the programs that can be supported may be tuned by raising and lowering the fixed amount of memory, with the lower amount of memory corresponding to a more severe limitation on the function of the computer 200.

When the display is sanctioned, the graphics and memory interface 204 may either limit the data sent to the graphics processor 208 or may send configuration settings that override existing user settings. For example, the number of pixels may be limited or the color depth may be reduced, depending on the requirements of the policy related to that state of operation. Another sanction may involve timing out the display after an interval from boot, for example, 10 minutes, allowing execution of recovery functions but limiting useful work periods.

The I/O interface 224 offers more opportunities to impose a sanction by limiting the function of the computer 200. Non-volatile memory 222 may be limited to read-only access, allowing programs to load, or data to be backed up, but not allowing page swapping to disk or user data to be stored. For this sanction to be fully effective, LAN 218 connections and USB ports 214 may also be restricted. When a read-only sanction may be too severe, non-volatile memory access may be set to allow read access at full speed and write access at a much lower rate, for example, less than 10% of the read rate. Setting data direction or limiting data rates may be accomplished by deactivating (e.g. setting to tri-state) write bus data buffers. Setting data rates may be accomplished by changing clock rates for data buffers in the interface.

Another method of limiting the effectiveness of a function may be to evaluate the type of data being accessed and allowing access to data files but blocking access to executable files. And exempt utility, such as a backup routine, may then provide limited access to the data files for backup purposes. In another embodiment, effectiveness of nonvolatile memory may be limited by slowing read access to a very low rate to discourage any use other than to add value or otherwise take steps to restore normal operation. Such a slow data rate may be less than 1% of the normally supported speed, or in one embodiment, a fixed rate of 10 Kbytes/second.

The I/O interface 210 may also limit the effectiveness of one of its connected functions by disabling communication with the local area network 218. This may block access to the Internet or to a local network. Alternatively, instead of disabling local area network communication, data transfer speeds may be restricted, or a maximum total volume limit of data transferred during a period of time may be imposed.

Similar to other data transfer restrictions, data transfers over the USB port 214 may be blocked or restricted. Because the USB port 214 may be used for a variety of peripherals, the impact may extend to a keyboard or mouse, a memory stick, a digital camera, a wireless network, or other device. As above, blocking or limiting data transfer rates may be accomplished by blocking or slowing the clock rate on data buffers in the I/O interface 210.

To revert the computer 200 to normal operation, a restoration code may need to be acquired from a licensing authority or service provider (not depicted) and entered into the computer 300. The restoration code may include the hardware ID 320, a stored value replenishment, and a “no-earlier-than” date used to verify the clock 322. The restoration code may typically be encrypted and signed for confirmation by the processing unit 302

A secure execution environment may be distinguished from a trusted computing base (TCB) or next generation secure computing base (NGSCB) in that the secure execution environment does not attempt to limit addition of features or functions to the computer, nor does it attempt to protect the computer from viruses, malware, or other undesirable side effects that may occur in use. The secure execution environment does attempt to protect the interests of an underwriter or resource owner to ensure that business terms, such as pay-per-use or subscriptions, are met and to discourage theft or pilfering of the computer as a whole or in part.

We claim:

1. A computer adapted for operation in an unrestricted use mode and a limited function mode comprising:
a processor;
a plurality of functional circuits; and
a support circuit coupled to the processor and at least one of the plurality of functional circuits, the support circuit comprising:
an interface for managing data communication between the processor and the at least one of the plurality of the functional circuits;
a state function reflecting a compliance status and for sending a signal activating a limited function operating mode; and
an enforcement function for adjusting the interface to impede effective performance of the at least one of the plurality of functional circuits responsive to the signal to activate the limited function operating mode.

2. The computer of claim 1, wherein the limited function mode is selected from a set of limited function modes comprising one of:
a) entering a payment;
b) configuring a network connection;
c) retrieving data;
d) disabling the computer but allowing user entry of a recovery code; and
e) disabling the computer and requiring authorized service technician intervention.

3. The computer of claim 2, wherein the enforcement function enables the selected limited function mode by controlling at least one of input/output access and memory availability.

4. The computer of claim 2, wherein the state function comprises a metering function and wherein the enforcement function selects the limited function mode from the set of limited function modes responsive to a signal from the metering function indicating a level of enforcement.

5. A method of limiting the performance of a computer comprising:
monitoring for a trigger event corresponding to activating a restricted mode of operation;
selecting a restricted mode of operation of the computer from a set of restricted modes of operation responsive to the trigger event;
activating the selected restricted mode of operation by limiting an effectiveness of a function at an interface circuit that couples the function to a processor.

6. The method of claim 5, wherein the function comprises at least one of a system memory function, a display function, a non-volatile memory access function, a Universal Serial Bus, and a network interface function.

7. The method of claim 5, wherein the function is a system memory function and limiting the effectiveness of the function comprises limiting system memory to less than 25% of a normally available system memory.

8. The method of claim 5, wherein the function is a system memory function and limiting the effectiveness of the function comprises limiting system memory to a fixed amount of memory available for processing, wherein a more severe limiting of functionality is achieved by lowering the fixed amount of memory available for processing.

9. The method of claim 5, wherein the function is a display function and limiting the effectiveness of the function comprises at least one of reducing a number of pixels available for displaying information, reducing the color depth/spectrum available, and automatically halting the display signal at the end of an interval.

10. The method of claim 5, wherein the function is a non-volatile memory access function and limiting the effectiveness of the function comprises at least one of limiting the non-volatile memory size available, limiting data access to read-only, limiting data access to write-only, limiting data access speed, and limiting data access accumulated size per powerup/reset.

11. The method of claim 5, wherein the function is a non-volatile memory access function and limiting the effectiveness of the function comprises limiting data access to read at full speed and write at a rate less than 10% of the read rate.

12. The method of claim 5, wherein the function is a non-volatile memory access function and limiting the effectiveness of the function comprises providing limited access to data files and no access to executable files.

13. The method of claim 5, wherein the function is a non-volatile memory access function and limiting the effectiveness of the function comprises limiting data access to read-only at a restricted data rate compared to a data rate available during normal operation.

14. The method of claim 5, wherein the function is a network interface function and limiting the effectiveness of the function comprises one of blocking access to a network, limiting a data transfer speed, and limiting a total data transferred during a period of time.

15. The method of claim 5, wherein the function is a Universal Serial Bus and limiting the effectiveness of the function comprises limiting a data transfer over the USB to write only.

16. A support circuit in a computer for processing signals carrying data between a processor and at least one function block of the computer comprising:
a plurality of bi-directional busses for sending and receiving data;
an interface circuit for processing and routing the signals among the plurality of busses;
an execution environment for monitoring compliance to an operating policy and enforcing the operating policy when the computer is not in compliance with the operating policy.

17. The support circuit of claim 16, wherein the execution environment comprises an enforcement circuit coupled to the interface circuit, wherein the enforcement circuit causes the interface circuit to limit processing and routing of the signals among the plurality of busses.

18. The support circuit of claim 16, wherein the execution environment comprises a cryptographic function for use in processing messages received at the execution environment.

19. The support circuit of claim 16, wherein the execution environment activates a limited function mode of the computer selected from a set of limited function modes, the selection corresponding to a degree of non-compliance with the operating policy.

20. The support circuit of claim 16, wherein the execution environment comprises a port for signaling an external enforcement function when the computer is not in compliance with the operating policy.
